(19) United States
(12) Patent Application Publication
(10) Pub. No.: US 2015/0350688 A1
(43) Pub. Date: Dec. 3, 2015

(54) I-FRAME FLASHING FIX IN VIDEO ENCODING AND DECODING

(71) Applicant: Apple Inc., Cupertino, CA (US)

(72) Inventors: Jian Lou, Cupertino, CA (US); Xiaojin Shi, Fremont, CA (US)

(21) Appl. No.: 14/696,032

(22) Filed: Apr. 24, 2015

Related U.S. Application Data
(60) Provisional application No. 62/005,228, filed on May 30, 2014.

(51) Int. Cl. H04N 19/895; H04N 19/18; H04N 19/172; H04N 19/103; H04N 19/159

(52) U.S. Cl. CPC H04N 19/895; H04N 19/103; H04N 19/159; H04N 19/172; H04N 19/18

(57) ABSTRACT

Methods and systems provide video compression to reduce a “flashing” effect, typically caused by skipping coding or allocating a low number of bits in coding relatively low complexity portions of frames. In an embodiment, if at least a portion of a sequence of frames is of relatively low complexity, a history of coding blocks may be considered to determine whether to skip coding. In an embodiment, a number of coding bits allocated to a block may be increased based on a history of the coding block and a likelihood of flashing. The history of coding of each pixel block may be a basis for forcing a higher quantization parameter coding of pixel block(s) of high motion portions such that a low bit rate is maintained despite a larger number of bits being allocated to flashing-susceptible blocks. In another embodiment, force coding of relatively low complexity portions may be delayed by a number of frames.

### CROSS-REFERENCE TO RELATED APPLICATION

This application claims benefit under 35 U.S.C. §119(e) of U.S. Provisional Application Ser. No. 62/005,228, filed May 30, 2014, which is incorporated herein by reference in its entirety.

### BACKGROUND

The present disclosure relates to a method of minimizing artifacts in video coding and compression. More specifically, it relates to methods for reducing “flashing” due to relatively low complexity portions of a sequence of video frames in video coding and processing systems such as within the High Efficiency Video Coding (HEVC) standard.

Many video compression standards, e.g. H.264/AVC and H.265/HEVC, currently published as ISO/IEC 23008-2 MPEG-H Part 2 and ITU-T H.265, have been widely used in video capture, video storage, real time video communication and video transcoding. Examples of popular applications include Apple AirPlay® Mirroring, FaceTime®, and video capture in iPhone® and iPad®.

Most video compression standards achieve much of their compression efficiency by motion compensating a reference picture and using it as a prediction for the current picture, and only coding the difference between the current picture and the prediction. The highest rates of compression can be achieved when the prediction is highly correlated to the current picture. When a portion of the view is generally not moving or is of relatively low complexity, i.e., substantially visually static from frame to frame for a duration of time, then there is high correlation of that portion to itself. When this happens, the video may be compressed by skipping the coding of that relatively low complexity portion for a number of frames, and/or coding the relatively low complexity portion with fewer bits than the more complex portions of the view.

However, skipping the coding or low number of bits in the coding of the relatively low complexity portions may cause small amount of errors to accumulate from reference frame to reference frame, such that eventually the accumulated error would be encoded into the video data, and upon decoding and displaying, the relatively low complexity portion shows a “flashing” or “beating” visual effect, which is particularly noticeable as a relatively large image change compared to the relatively low complexity portion, in for example luminance, color, etc. Generally, this “flashing” occurs particularly when refresh frames (e.g., intra frame or instantaneous decoder refresh frames) are displayed every 30 or so frames (approximately every 1 second) in the video data, which makes the “flashing” or “beating” effect resemble a heartbeat.

This “flashing” effect may be minimized by not skipping the coding of the relatively low complexity portions and/or increasing a number of bits used for the coding of the relatively low complexity portions. However, doing so significantly increases a required number of bits in the coded video data, causing increase in computational time and decrease in compression efficiency, which is not acceptable for many applications.

### BRIEF DESCRIPTION OF THE DRAWINGS

FIG. 1 is a block diagram of a multi-terminal system implementing the methods and systems described herein.

FIG. 2 is a block diagram of a coding and decoding system implementing the methods and systems described herein.

FIG. 3 is a simplified block diagram of a coding system according to an embodiment of the present disclosure.

FIG. 4 is a simplified conceptual diagram of a sequence of frames coded according to an embodiment of the present disclosure.

FIG. 5 is a flowchart illustrating a method for video compression according to an embodiment of the present disclosure.

FIG. 6A is a flowchart illustrating another method for video compression according to an embodiment of the present disclosure.

FIG. 6B is a flowchart illustrating another method for video compression according to an embodiment of the present disclosure.

### DETAILED DESCRIPTION

Methods and systems provide removal of a flashing artifact from a sequence of frames of video data. In an embodiment, a method compares a first frame of the video data to a second frame of the video data. The method may then determine that at least a portion of the first frame and a corresponding portion of the second frame of relatively low complexity based on the comparing. The method may determine a likelihood of flashing being present in the relatively low complexity portions of the first frame and the second frame, based on a tracked history of at least one block associated with the at least a portion of the first frame and the second frame. The method may then code the at least one associated block based on the first frame and the second frame responsive to a determination that the flashing artifact is more likely than not present.

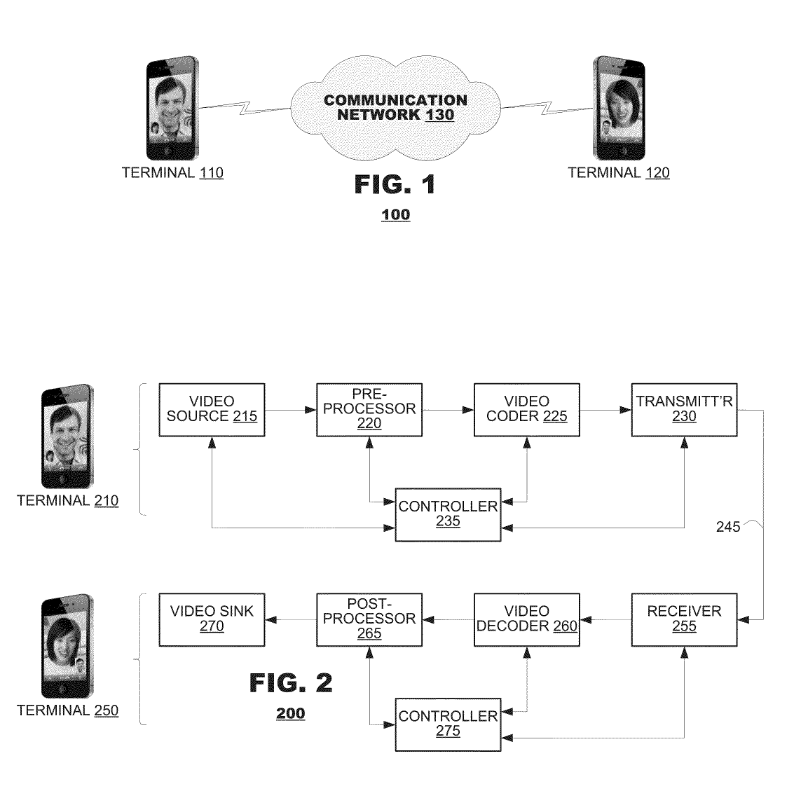

FIG. 1 illustrates a simplified block diagram of a video coding system 100 according to an embodiment of the present disclosure. The system 100 may include at least two terminals 110-120 interconnected via a network 130. For unidirectional transmission of data, a first terminal 110 may code video data at a local location for transmission to the other terminal 120 via the network 130. The second terminal 120 may receive the coded video data of the other terminal from the network 130, decode the coded data and display the recovered video data. Unidirectional data transmission is common in media serving applications and the like.

For bidirectional transmission of data, however, each terminal 110, 120 may code video data captured at a local location for transmission to the other terminal via the network 130. Each terminal 110, 120 also may receive the coded video data transmitted by the other terminal, may decode the coded data and may display the recovered video data at a local display device.

In FIG. 1, the terminals 110-120 are illustrated as smart phones but the principles of the present disclosure are not so limited. Embodiments of the present disclosure find application with laptop computers, tablet computers, servers, media players and/or dedicated video conferencing equipment. The network 130 represents any number of networks that convey coded video data among the terminals 110-120, including, for example, wireline and/or wireless communication networks. The communication network 130 may exchange data in circuit-switched and/or packet-switched channels. Representative networks include telecommunications networks, local area networks, wide area networks and/or the Internet. For the purposes of the present discussion, the architecture and topology of the network 130 is immaterial to the operation of the present disclosure unless explained herein below.

FIG. 2 is a functional block diagram of a video coding system 200 according to an embodiment of the present disclosure. In this example, only the components that are relevant to a unidirectional coding session are illustrated. The video coding system 200 may include a video source 215, a pre-processor 220, a video coder 225, a transmitter 230, and a controller 235.

The video source 215 may provide video to be coded by the terminal 210. In a videoconferencing system, the video source 215 may be a camera that captures local image information as a video sequence or it may be a locally-executing application that generates video for transmission (such as in gaming or graphics authoring applications). In a media serving system, the video source 215 may be a storage device storing previously prepared video.

The pre-processor 220 may perform various analytical and signal conditioning operations on video data. For example, the pre-processor 220 may search for video content in the source video sequence that is likely to generate artifacts when the video sequence is coded, decoded, and displayed. The pre-processor 220 also may apply various filtering operations to the frame data to improve efficiency of coding operations applied by a video coder 225.

The video coder 225 may perform coding operations on the video sequence to reduce the bit rate of a sequence. The video coder 225 may code the input video data by exploiting temporal and spatial redundancies in the video data. The transmitter 230 may buffer coded video data and to prepare it for transmission to a second terminal 250. The controller 235 may manage operations of the first terminal 210,

The first terminal 210 may operate according to a coding policy, which may be implemented by the controller 235 and video coder 225. The controller 235 may select coding parameters to be applied by the video coder 225 in response to various operational constraints. Such constraints may be established by, among other things: a data rate that is available within the channel to carry coded video between terminals, a size and frame rate of the source video, a size and display resolution of a display at a terminal 250 that will decode the video, and error resiliency requirements required by a protocol by which the terminals operate. Based upon such constraints, the controller 235 and/or the video coder 225 may select a target bit rate for coded video (for example, as N bits/sec) and an acceptable coding error for the video sequence. Thereafter, they may make various coding decisions to individual frames of the video sequence. For example, the controller 235 and/or the video coder 225 may select a frame type for each frame, a coding mode to be applied to pixel blocks within each frame, and quantization parameters to be applied to frames and or pixel blocks.

During coding, the controller 235 and/or video coder 225 may assign to each frame a certain frame type, which can affect the coding techniques that are applied to the respective frame. Frames commonly are parsed spatially into a plurality of pixel blocks (for example, blocks of 4×4, 8×8, 16×16, 32×32, 64×64 pixels each) and coded on a pixel-block-by-pixel-block basis. Pixel blocks may be coded predictively with reference to other coded pixel blocks as determined by the coding assignment applied to the pixel blocks' respective frame. For example, pixel blocks of Intra Frames (“I frames”) can be coded non-predictively or they may be coded predictively with reference to pixel blocks of the same frame (spatial prediction). Pixel blocks of Predictive Frames (“P frames”) may be coded non-predictively, via spatial prediction or via temporal prediction with reference to one previously coded reference frame. Pixel blocks of Bidirectionally Predictive Frames (“B frames”) may be coded non-predictively, via spatial prediction or via temporal prediction with reference to one or two previously coded reference frames.

FIG. 2 also illustrates components of a second terminal 250 that may receive and decode the coded video data. The second terminal may include a receiver 255, a video decoder 260, a post-processor 265, a video sink 270; and a controller 275 to manage overall operation of the second terminal 250.

Receiver 255 may receive coded data from a channel 245 and parse it according to its constituent elements. For example, the receiver 255 may distinguish coded video data from coded audio data and route each coded data to decoders to handle them. In the case of coded video data, the receiver 255 may route it to the video decoder 260.

Video decoder 260 may perform decoding operations that invert processes applied by the video coder 225 of the first terminal 210. Thus, the video decoder 260 may perform prediction operations according to the coding mode that was identified and perform entropy decoding, inverse quantization and inverse transforms to generate recovered video data representing each coded frame.

Post-processor 265 may perform additional processing operations on recovered video data to improve quality of the video prior to rendering. Filtering operations may include, for example, filtering at pixel block edges, anti-banding filtering and the like.

Video sink 270 may consume the reconstructed video. The video sink 270 may be a display device that displays the reconstructed video to an operator. Alternatively, the video sink may be an application executing on the second terminal 250 that consumes the video (as in a gaming application).

FIG. 2 illustrates only the components that are relevant to unidirectional exchange of coded video. As discussed, the principles of the present disclosure also may apply to bidirectional exchange of video. In such an embodiment, the elements 215-235 illustrated for capture and coding of video at the first terminal 210 may be replicated at the second terminal 250. Similarly the elements 255-275 illustrated for decoding and rendering of video at the second terminal 250 may be replicated at the first terminal 210. Indeed, it is permissible for terminals 210, 250 to have multiple instantiations of these elements to support exchange of coded video with multiple terminals simultaneously, if desired.

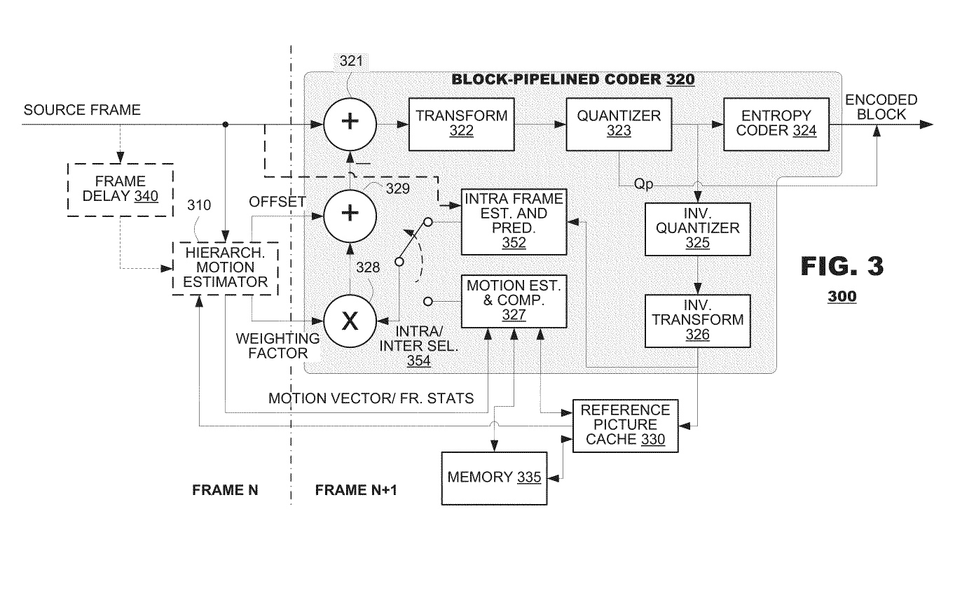

FIG. 3 illustrates a video coder 300 according to an embodiment of the present disclosure. The video coder 300 may include: a block-pipelined coder (“BPC”) 320, a reference picture cache 330, and a memory 335. In an embodiment, the video coder 300 may optionally include a hierarchical motion estimator (HME) 310.

The video coder 300 may operate in a pipelined fashion where the HME 310 operates on data from one frame (labeled “frame N” herein), while the BPC 320 operates on data from the same frame (“frame N”).

The HME 310 may estimate motion of image content from the content of a frame. Typically, the HME 310 may analyze frame content at two or more levels of data to estimate motion. The HME 310, therefore, may output a motion vector representing identified motion characteristics that are observed in motion content. The motion data may be output to the BPC 320 to aid in prediction operations.

The HME 310 also may perform statistical analysis of the frame N and output data representing those statistics. The statistics also may be output to the BPC 320 to assist in mode selection operations, discussed below. The HME 310 further may determine weighting factors and offset values to be used in weighted prediction. The weighting factors and offset values also may be output to the BPC 320.

The BPC 320 may include: a subtractor 321, a transform unit 322, a quantizer 323, an entropy coder 324, an inverse quantizer 325, an inverse transform unit 326, an intra frame estimation and prediction unit 352, a motion estimation and compensation unit 327 that performs motion prediction, a mode selector 354, a multiplier 328, and an adder 329.

The BPC 320 may operate on an input frame on a pixel-block-by-pixel-block basis. Typically, a frame of content may be parsed into a plurality of pixel blocks, each of which may correspond to a respective spatial area of the frame. The BPC 320 may process each pixel block individually.

The subtractor 321 may perform a pixel-by-pixel subtraction between pixel values in the source frame and any pixel values that are provided to the subtractor 321 by the motion estimation and compensation units 327-329. The subtractor 321 may output residual values representing results of the subtraction on a pixel-by-pixel basis. In some cases, the motion estimation and compensation units 327-329 may provide no data to the subtractor 321 in which case the subtractor 321 may output the source pixel values without alteration.

The transform unit 322 may apply a transform to a pixel block of input data, which converts the pixel block to an array of transform coefficients. Exemplary transforms may include discrete sine transforms, discrete cosine transforms, and wavelet transforms. The transform unit 322 may output transform coefficients for each pixel block to the quantizer 323.

The quantizer 323 may apply a quantization parameter Qp to the transform coefficients output by the transform unit 322. The quantization parameter Qp may be a single value applied uniformly to each transform value in a pixel block or, alternatively, it may represent an array of values, each value being applied to a respective transform coefficient in the pixel block. The quantizer 323 may output quantized transform coefficients to the entropy coder 324.

The entropy coder 324, as its name applies, may perform entropy coding of the quantized transform coefficients presented to it. The entropy coder 324 may output a serial data stream, representing the quantized transform coefficients. Typical entropy coding schemes include arithmetic coding, Huffman coding and the like. The entropy coded data may be output from the BPC 320 as coded data of the pixel block. Thereafter, it may be merged with other data such as coded data from other pixel blocks and coded audio data and be output to a channel (not shown).

The BPC 320 may include a local decoder formed of the inverse quantizer unit 325, inverse transform unit 326, and an adder (not shown) that reconstruct select coded frames, called “reference frames.” Reference frames are frames that are selected as a candidate for prediction of other frames in the video sequence. When frames are selected to serve as reference frames, a decoder (not shown) decodes the coded reference frame and stores it in a local cache for later use. The encoder also includes decoder components so it may decode the coded reference frame data and store it in its own cache. Thus, absent transmission errors, the encoder's reference picture cache 330 and the decoder's reference picture cache (not shown) should store the same data.

The inverse quantizer unit 325 may perform processing operations that invert coding operations performed by the quantizer 323. Thus, the transform coefficients that were divided down by a respective quantization parameter may be scaled by the same quantization parameter. Quantization often is a lossy process, however, and therefore the scaled coefficient values that are output by the inverse quantizer unit 325 oftentimes will not be identical to the coefficient values that were input to the quantizer 323.

The inverse transform unit 326 may inverse transformation processes that were applied by the transform unit 322. Again, the inverse transform unit 326 may apply inverses of discrete sine transforms, discrete cosine transforms, or wavelet transforms to match those applied by the transform unit 322. The inverse transform unit may generate pixel values, which approximate prediction residuals input to the transform unit 322.

Although not shown in FIG. 3, the BPC 320 may include an adder to add predicted pixel data to the decoded residuals output by the inverse transform unit 326 on a pixel-by-pixel basis. The adder may output reconstructed image data of the pixel block. The reconstructed pixel block may be assembled with reconstructed pixel blocks for other areas of the frame and stored in the reference picture cache 330.

The mode selector 354 may perform mode selection operations for the input pixel block. In doing so, the mode selector 354 may select a type of coding to be applied to the pixel block, for example intra-prediction, unidirectional inter-prediction or bidirectional inter-prediction. For either type of inter prediction, the motion estimation and compensation unit 327 may perform a prediction search to identify from a reference picture stored in the reference picture cache 330 to serve as a prediction reference for the input pixel block.

The intra frame estimation and prediction unit 352 may use Intra prediction, which uses the pixels in the current frame to generate prediction. When performing Intra prediction, the intra frame estimation and prediction unit 352 may use only the reconstructed pixels within the same frame and does not use data from the reference frame cache 330. The intra frame estimation and prediction unit 352 and the motion estimation and compensation unit 327 may generate identifiers of the prediction reference by providing motion vectors, Intra prediction modes or other metadata (not shown) for the prediction. The motion vector may be output from the BPC 320 along with other data representing the coded block.

The motion estimation and compensation unit 327 may also determine that the input pixel block is a relatively low complexity portion by obtaining the analysis from previous frame statistics. Based upon a determination that the input pixel block is a relatively low complexity portion, the motion estimation and compensation unit 327 may further analyze the history of the pixel blocks from the memory 335 as corresponding to the reference pixel blocks stored in the reference picture cache 330. Then, the motion estimation and compensation unit 327 may control the various other portions of BPC 320 to implement compression and coding of the input pixel block of a relatively low complexity portion.

For example, the motion estimation and compensation unit 327 may determine whether the input pixel block of a relatively low complexity portion should be skipped in coding, be allocated a default number of bits for coding, or be allocated additional bits for coding (for example in a P frame or a B frame), based upon the history of coding for that same pixel block. The motion estimation and compensation unit 327 may maintain and update the history of the pixel blocks from the memory 335 in reference to the reference pixel blocks stored in the reference picture cache 330.

“Skipped in coding” may represent several different scenarios of coding for a pixel block in various embodiments. In an embodiment according to the present disclosure, “skipped in coding” for a pixel block may indicate that the pixel block has no residual image information for coding, (but there may be motion vectors for the pixel block for coding).

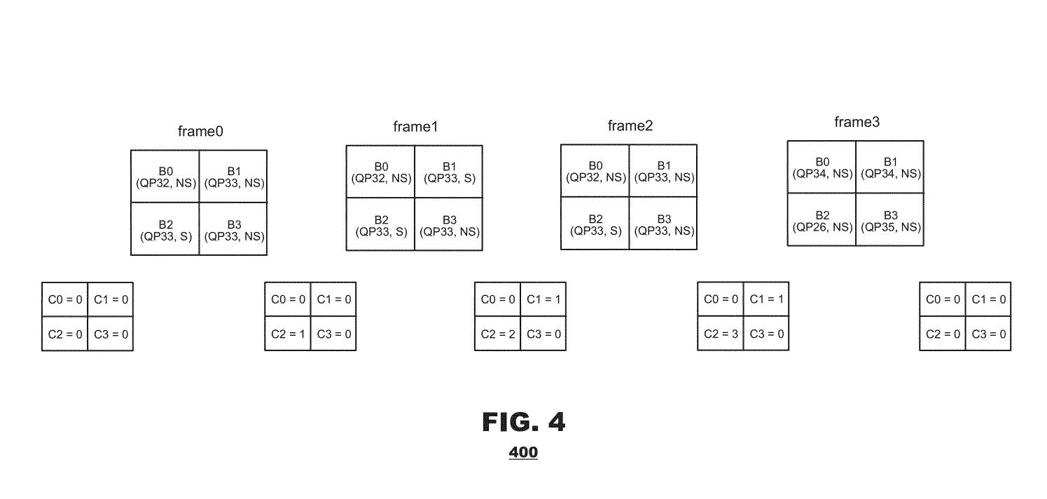

The memory 335 may store a sequence of frames such as the sequence of frames shown in FIG. 4. The memory 335 may store a first set of counter values, a counter value corresponding to each of the pixel blocks of each of the frames, maintained and/or updated by the motion estimation and compensation unit 327. The first set of counter values (a skip counter) may each represent a running count of how many times a corresponding pixel block has been skipped in coding. The storing of the counter values tracks a history of coding blocks and may be used to determine whether to skip coding, maintain a default number of bits for coding, or increase a number of bits allocated for coding as further described herein.

The multiplier 328 and adder 329 may apply a weighting factor and offset to the predicted data generated by the motion estimation and compensation unit 327. Specifically, the multiplier 328 may scale the predicted data according to the weighting factor provided by the HME 310. The adder 329 may add an offset value to the output of the multiplier, again, using a value that is provided by the HME. Data output from the adder 329 may be input to the subtractor 321 as prediction data.

The principles of the present disclosure reduce or fix “flashing” effects in the video by analyzing the history of coding blocks using the BPC 320, and slightly increasing a number of coding bits more frequently compared with conventional methods to reduce accumulation of errors that may lead to the “flashing” effect, without significantly increasing overall number of coding bits. In an embodiment, the BPC 320 may be configured to reduce flashing effects as described herein, for example by performing methods 500, 600, and/or 650. Thus, the principles of the present disclosure reduce visual artifacts without compromising video compression and coding efficiencies. The concepts of the present disclosure apply as well to other encoders, e.g., encoders conforming to other standards or including additional filtering such as deblock filtering, sample adaptive offset, etc.

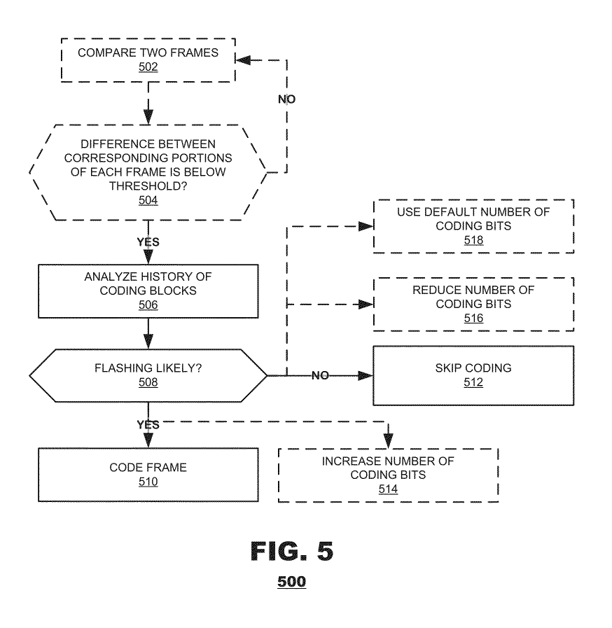

FIG. 5 illustrates a method 500 for video compression according to an embodiment of the present disclosure. The method 500 may analyze a history of pixel block coding over multiple frames to determine whether flashing is likely (box 506). The history of coding the blocks may be analyzed according to the methods described further herein. Based on the history of coding, method 500 may determine whether flashing is likely (box 508). If flashing is not likely, method 500 may proceed to code the frames according to conventional methods, i.e., skipping coding (box 512), use a default number of bits for coding (box 518), or otherwise reducing a number of coding bits allocated to those blocks (box 516). However, if method 500 determines that flashing is likely, method 500 may code the frames instead of skipping coding (box 510). In an alternative embodiment, method 500 may increase a number of coding bits allocated to the blocks (box 514).

In an embodiment, the method 500 may compare two frames (box 502). Based on at least a portion of each frame, method 500 may determine whether a region is of relatively low complexity. For example, method 500 may determine that a region is of relatively low complexity if a difference between a first version of the region in a first frame and a second version of the same region in a different frame is below a difference threshold (box 504). If method 500 identifies a relatively low complexity region, the method 500 may then proceed to analyze a history of coding the corresponding blocks in multiple frames (box 506).

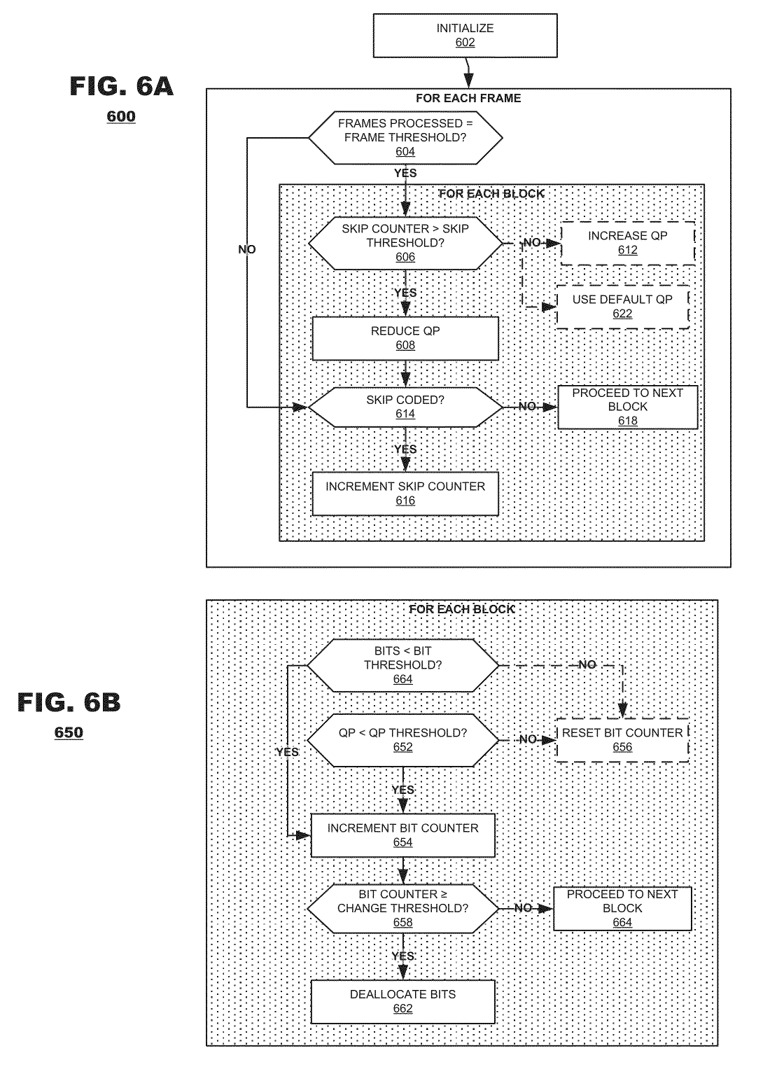

FIG. 6A illustrates a method 600 for video compression according to an embodiment of the present disclosure. As shown, the method 600 may operate on a sequence of video frames and pixel blocks of each frame. In an embodiment, method 600 is performed for a sequence of frames that have relatively low complexity content, e.g., as determined in box 504 of method 500.

Method 600 may begin by initializing (box 602). The initializing may include setting or resetting one or more counters used by method 600. For each frame, the method 600 may then determine whether a number of frames processed is equal to a frame threshold (box 604). The frame threshold may determine a frequency of performing particular portions of method 600. The frame threshold may be set based on a frame rate. If the frame rate of the video encoding changes, the frequency of the checking and resetting of counters may be adjusted to ensure that the checking is performed sufficiently frequently in any given time period.

If the method 600 determines that the number of frames processed is not equal to the threshold, the method 600 may then determine, for each pixel block of the frame, whether the block is skip coded (box 614). If coding is skipped, method 600 may advance a corresponding counter (“skip counter”) for the block (box 616). If, however, coding is not skipped, method 600 may proceed to processing the next block in the frame (box 618). The skip counter may track the number of times a block is skip coded.

If the number of frames processed is equal to the frame threshold, method 600 may determine whether a skip counter for a pixel block exceeds a skip threshold (box 606). If the skip counter exceeds the skip threshold, the method may decrease a quantization parameter for the block (box 608). Decreasing a quantization parameter may increase the number of bits used for coding. In an embodiment, if the skip counter does not exceed the skip threshold, the method 600 may or use a default quantization parameter for the block (box 622) or may increase the quantization parameter for the block (box 612). Increasing a quantization parameter may decrease the number of bits used for coding. Performing optional step 612 or step 622 for a block may compensate for any increase in bits used for coding of other pixel blocks in a frame. Thus, an overall number of bits consumed (i.e., bitrate) for coding the frame is maintained or reduced. As shown, boxes 606-618 may be performed for each block in a frame.

In an embodiment (not shown), block coding decisions may be delayed by one or more frames so that statistics from preceding frames are not used for an immediately subsequent frame. The number of frames by which to delay block coding may be based on available computational resources and channel speed. For instance, if resources are insufficient, force coding (i.e., increasing bits allocated or non-skip coding) of relatively low complexity portions may be delayed by a few frames.

FIG. 6B illustrates a method 650 for video compression according to an embodiment of the present disclosure. The method 650 may be performed for each block of a frame. The method 650 may be performed in combination with the method 600.

The method 650 may determine whether a number of encoded bits is above a bit threshold (box 652). If the number of encoded bits is above the bit threshold, the method 650 may reset a bit counter (box 656). In box 652, the method 650 may determine whether a quantization parameter (QP) for the block is less than a QP threshold (box 652). If a QP is not less than the QP threshold, the method 650 may reset a bit counter (box 656).

The bit counter may track how often a block is coded with a relatively high number of bits, i.e., has a relatively low QP. If the QP is less than the QP threshold, the method 650 may increment the bit counter (box 654). The method 650 may then proceed to box 658 to determine whether the bit counter is greater than or equal to a change threshold. Being above a change threshold may indicate that a pixel block changes relatively frequently from frame to frame. Being above a change threshold may indicate that a pixel block contains a relatively large amount of pixel changes. If the bit counter is greater than or equal to the change threshold, the method 650 may de-allocate a number of bits used for coding the block (box 662). However, if the bit counter is less than the change threshold, the method 650 may proceed to the next block (box 664).

In an embodiment (not shown), the method 650 may also determine whether a complexity of the block is below a complexity threshold. This may indicate that the block is of relatively low complexity. If the bit counter exceeds the change threshold and the block is of relatively low complexity, method 600 may deallocate bits for coding the block. If either or both conditions are not true, method 600 may proceed to the next block.

FIG. 4 is a block diagram of a sequence 400 of frames (frame0-frame3) coded with several pixel blocks (B0-B3). Methods 600 and 650 may be performed on the sequence of frames 400. Counter values (C0-C3) corresponding to each of the frames are also shown in FIG. 4. Counter C0 corresponds to block B0, counter C1 corresponding to block B1, counter C2 corresponds to block B2, and counter C3 corresponds to block B3. Each of the counters may track a number of times the corresponding block is skipped, i.e., the counters may be skip counters.

Each frame shown in FIG. 4 includes four blocks (B0-B3). A quantization parameter associated with each block is represented as QP followed by an exemplary QP value. Whether a block is to be skipped is represented as S or NS, where S represents skipped and NS represents not skipped. Counter values for an associated block are shown for a state of a block prior to a frame (to the left of the frame) and also for a state of the block after a frame (to the right of the frame).

In FIG. 4, a sequence of frames starts on the left, where the skip counter (C0-C3) corresponding to each block (B0-B3) is set or reset to 0 at the beginning of the sequence (box 602 of FIG. 6). This beginning of the sequence may denote the beginning of a video or immediately after a refresh frame (I frame or IDR frame). Skip counter values may be reset after a refresh frame, as the refresh frame effectively resets video encoding data in the video stream.

In encoding frame0, pixel blocks B0, B1, and B3 are not skipped coded (NS), and pixel block B2 is skipped coded (S). Upon or after encoding frame0, the skip counter C2 (corresponding to skipped coded pixel block B2) is incremented by 1 (box 616 of FIG. 6A). The skip counters C0, C1, and C3 are not incremented because they are not skipped coded.

In encoding frame1, pixel blocks B0 and B3 are not skipped coded (NS), and pixel blocks B1 and B2 are skipped coded (S). Upon or after encoding frame1, the skip counters C1 and C2 (corresponding to skipped coded pixel blocks B1 and B2) are each incremented by 1 (box 616 of FIG. 6A). The skip counters C0 and C3 are not incremented because they are not skipped coded.

In encoding frame2, B0, B1 and B3 are not skipped coded (NS), and pixel block B2 is skipped coded (S). Upon or after encoding frame2, the skip counter C2 (corresponding to skipped coded pixel block B2) is incremented by 1 (box 616 of FIG. 6A). The counter C0, C1, and C3 are not incremented because they are not skipped coded.

Suppose a frame threshold is set to 3. In this scenario, the statistics of the counters are checked and then reset once every 3 frames (i.e. statistics of 3 frames are used to make coding decisions for a 4th frame). However, the frequency of the checking and resetting of the counters may increase or decrease. For example, if the frame rate of the video encoding changes, the frequency of the checking and resetting of the counters may be adjusted to ensure that the checking is done sufficiently frequently in any given time period.

Upon reaching frame3, a number of processed frames matches the frame threshold because frame0, frame1, and frame2 have been processed (box 604 of FIG. 6A). Thus, before encoding frame3, the skip counters for each block are checked (box 606 of FIG. 6A). If any of the skip counters (C0-C3) has a value larger than a skip threshold (for example, 2), a quantization parameter for the corresponding pixel block is decreased (box 608 of FIG. 6A).

In this case, before encoding frame3, skip counter C2 has a value of 3, which is greater than the threshold of 2. Thus, pixel block B2 is given a reduced QP value (QP of 26 in frame3). Optionally, in order to reduce (or not increase) the bitrate for frame3, the pixel blocks with skip counter values below the skip threshold (or another threshold) may use default quantization parameter for the block (box 622), may have their QP values increased to reduce the bits for their coding (box 612 of FIG. 6A). In this case, for example, pixel blocks B0, B1 and B3 have their QP values increased between frame2 and frame3.

Upon or after encoding frame3, the skip counters (C0-C3) are all reset to 0, and then based upon frame3 coding, any skip counters (C0-C3) corresponding to a skipped coded (S) pixel block in frame3 may be incremented by 1 (boxes 614 and 616 of FIG. 6A). Here none of the pixel blocks (B0-B3) are skipped coded, thus, none of the skip counters (C0-C3) incremented.

This process may be iterated over a whole video sequence, i.e. statistics of the counters from frames 0, 1, 2 may be used for frame 3, statistics from frame 3, 4, 5 may be used for frame 6, statistics from frame 6, 7, 8 may be used for frame 9, etc. As discussed herein, in an embodiment, the block coding decisions may be delayed (by, for example, one frame), such that statistics from frame 0, 1, 2 are used for frame 4, statistics from frame 4, 5, 6 are used for frame 8, statistics from frame 8, 9, 10 are used for frame 12. If resources such as computational resources or network resources are not sufficiently available, force coding of relatively low complexity portions may be delayed by a few frames.

Additionally, a memory may store a second set of counter values that includes a counter value for each pixel block, maintained or updated by the prediction unit. The second set of counter values may each represent a running count of how many times a corresponding pixel block has been coded with a number of bits above a threshold value (a high bit counter). For example, a “very high number of bits” may be defined by a number of bits being above the threshold value. Each time a pixel block is coded with a QP value that is lower than some preset amount in a frame, the prediction unit may control the memory to increment the high bit counter value for the pixel block. If a pixel block is skipped coded or the QP value is higher than another preset amount such that a lower number of bits are used for the coding, the high bit counter value for the pixel block may be reset to zero.

In an embodiment, the prediction unit may control the various other portions of a block-pipelined coder to deallocate bits for coding of a specific pixel block (for example, by increasing QP value of the pixel block). Whether a current pixel block is of relatively low complexity may be determined by the pixel block being in a portion of the video sequence with complexity below a complexity threshold. In effect, the prediction unit looks at the history of coding of each pixel block, and forces higher QP value coding of any pixel block of high motion portions to reduce number of bits in the high motion portions. The effect of reduction of bits in the coding of high motion portions is not very noticeable during display, as compared to the high degree of visual changes in the low motion portions. This allows additional saving of bits in compression and coding, and compensates for additional bits allocated to force coding the relatively low complexity portions.

Alternatively, the memory may simply store a running history of QP values for each pixel block coded. This would allow the prediction unit to perform more flexible history analysis of each pixel block on the fly where counter values and preset threshold values may be inflexible relative to variations of coding within the video data. For example, a video stream may switch frame rate, depending on lighting conditions. Counter values may not be sufficient alone to compensate for the change in frame rate and the corresponding error accumulation rate. Thus, a more holistic decision may be made by the prediction unit based upon the history of the QP values that determines potential error accumulation in time (instead of over number of frames) for each pixel block and noticeability for each pixel block. A flashing effect may occur if the error accumulation rate exceeds a threshold (“error threshold”). For example, flashing of a relatively dark pixel block may be more noticeable when the error is in the luminance. In other words, a flashing effect may occur or a flashing effect may be more noticeable for a relatively dark pixel block. A pixel block may be determined to be relatively dark if the luminance of the pixel block is below a luminance threshold.

Although the foregoing description includes several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

As used in the appended claims, the term “computer-readable medium” may include a single medium or multiple media, such as a centralized or distributed database, and/or associated caches and servers that store one or more sets of instructions. The term shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

The present specification describes components and functions that may be implemented in particular embodiments which may operate in accordance with one or more particular standards and protocols. However, the disclosure is not limited to such standards and protocols. Such standards periodically may be superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

For example, operation of the disclosed embodiments has been described in the context of servers and terminals that implement video compression, coding, and decoding. These systems can be embodied in electronic devices or integrated circuits, such as application specific integrated circuits, field programmable gate arrays and/or digital signal processors. Alternatively, they can be embodied in computer programs that execute on personal computers, notebook computers, tablets, smartphones or computer servers. Such computer programs typically are stored in physical storage media such as electronic-, magnetic- and/or optically-based storage devices, where they may be read to a processor, under control of an operating system and executed. And, of course, these components may be provided as hybrid systems that distribute functionality across dedicated hardware components and programmed general-purpose processors, as desired.

In addition, in the foregoing Detailed Description, various features may be grouped or described together the purpose of streamlining the disclosure. This disclosure is not to be interpreted as reflecting an intention that all such features are required to provide an operable embodiment, nor that the claimed embodiments require more features than are expressly recited in each claim. Rather, as the following claims reflect, subject matter may be directed to less than all of the features of any of the disclosed embodiments. Thus, the following claims are incorporated into the Detailed Description, with each claim standing on its own as defining separately claimed subject matter.

Also, where certain claims recite methods, sequence of recitation of a particular method in a claim does not require that that sequence is essential to an operable claim. Rather, particular method elements or steps could be executed in different orders without departing from the scope or spirit of the invention.

What is claimed is:

1. A method, comprising:
determining for a given frame, from coding of frames preceding the given frame, whether a flashing effect is likely to occur from a default coding mode,
if a flashing effect is determined to be likely, assigning an alternate coding mode to image content in a region of the given frame,
otherwise, assigning the default coding mode to image content in the region, and
thereafter, coding image content of the region according to the assigned mode.

2. The method of claim 1, further comprising:
identifying the region from among a plurality of frames of a video sequence to be coded, based on the region having low complexity, and
wherein when the region is identified, performing the determining whether a flashing effect is likely to occur from a default coding mode.

3. The method of claim 1, wherein the default coding mode includes skip coding and the alternate coding mode includes coding.

4. The method of claim 1, wherein the default coding mode causes the image content to be coded according to a first number of bits and the alternate coding mode causes the image content to be coded according to a second number of bits, higher than the first number of bits.

5. The method of claim 2, wherein the region in the frames is determined to have low complexity if a difference between the region in a first frame and a corresponding region in a second frame is below a difference threshold.

6. The method of claim 1, further comprising:
initializing a skip counter for at least one block of the region;
if the at least one block is skip coded, incrementing the skip counter; and
if the skip counter is above a skip threshold, decreasing a quantization parameter for the at least one block; and
wherein the assigning the alternate coding mode is based on the quantization parameter.

7. The method of claim 6, wherein the assigning the alternate coding mode is based on:
if the quantization parameter is below a quantization parameter (QP) threshold, incrementing a bit counter;
if the at least one block is encoded with a number of bits above a bit threshold, incrementing the bit counter; and
if the bit counter is above a change threshold, deallocating a number of coding bits for the at least one block.

8. The method of claim 7, wherein the deallocating the number of coding bits is performed such that a respective quantization parameter is increased for a block having a motion above a motion threshold to compensate for bits allocated to the at least one block.

9. The method of claim 7, wherein if the respective quantization parameter is above the QP threshold, resetting the bit counter.

10. The method of claim 6, wherein the assigning the alternate coding mode is based on:
if the skip counter is below the skip threshold, increasing a quantization parameter for the at least one block such that a number of bits consumed for the coding image content of the region is one of: unchanged and decreased.

11. The method of claim 6, wherein the determining whether the skip counter is above the skip threshold is performed if a number of coded frames preceding the given frame is equal to a frame threshold.

12. The method of claim 11, wherein the frame threshold is set such that the skip counter is checked and reset periodically, the frame threshold being based on a frame rate of encoding.

13. The method of claim 12, wherein a block coding decision including the assigning the alternate coding mode is delayed by at least one frame based on an availability of computing resources.

14. The method of claim 1, wherein the determining whether a flashing effect is likely to occur includes:
calculating an error accumulation rate based on quantization parameters for frames preceding the given frame; and
determining that a flashing effect is likely to occur if the error accumulation rate exceeds an error threshold.

15. The method of claim 14, wherein the flashing effect is likely to occur if the error accumulation rate indicates a block having a luminance below a luminance threshold.

16. A video coding system comprising:
a reference picture cache storing a plurality of frames of a video sequence to be coded;
a block-pipelined coder configured to:
when the region is identified, determine for a given frame, from coding of frames preceding the given frame, whether a flashing effect is likely to occur from a default coding mode,
if a flashing effect is determined to be likely, assign an alternate coding mode to image content in a region in the plurality of frames having low complexity,
otherwise, assign the default coding mode to image content in the region, and
thereafter, code image content of the region according to the assigned mode.

17. The system of claim 16, wherein the default coding mode causes the image content to be coded according to a first number of bits and the alternate coding mode causes the image content to be coded according to a second number of bits, higher than the first number of bits.

18. The system of claim 16, the block-pipelined coder is further configured to:
initialize a skip counter for at least one block of the region;
increment the skip counter if the at least one block is skip coded; and
decrease a quantization parameter for the at least one block if the skip counter is above a skip threshold; and
wherein the assigning the alternate coding mode is based on the quantization parameter.

19. A non-transitory computer-readable medium storing program instructions that, when executed, cause a processor to perform a method, the method comprising:
determining for a given frame, from coding of frames preceding the given frame, whether a flashing effect is likely to occur from a default coding mode,
if a flashing effect is determined to be likely, assigning an alternate coding mode to image content in a region in the frames having low complexity,
otherwise, assigning the default coding mode to image content in the region, and
thereafter, coding image content of the region according to the assigned mode,
wherein the default coding mode causes the image content to be coded according to a first number of bits and the alternate coding mode causes the image content to be coded according to a second number of bits, higher than the first number of bits.

20. The non-transitory computer-readable medium of claim 19, wherein the method further comprises:
initializing a skip counter for at least one block of the region;
if the at least one block is skip coded, incrementing the skip counter; and
if the skip counter is above a skip threshold, decreasing a quantization parameter for the at least one block; and
wherein the coding the image content of the region is based on the quantization parameter.
